(19) United States
(12) Patent Application Publication
(10) Pub. No.: US 2003/0095120 A1
(43) Pub. Date: May 22, 2003

(54) Method and device for the simultaneous display of arbitrarily selectable, complementary sectional images

(76) Inventors: Reiner Koppe, Hamburg (DE); Erhard Paul Artur Klotz, Neumuenster (DE); Johannes Catharina Antonius Op De Beek, Eindhoven (NL)

Correspondence Address: Eugene E. Clair III, Philips Medical Systems (Cleveland) Inc., 595 Miner Road, Cleveland, OH, 44143, US

(21) Appl. No.: 10/300,458

(22) Filed: Nov. 19, 2002

(30) Foreign Application Priority Data
Nov. 22, 2001 (DE) 10157268.9

(51) Int. Cl. G06T 15/00

(52) U.S. Cl. 345/419

(57) ABSTRACT

The invention relates to a method for the simultaneous display of at least two sectional images taken through a volume reconstructed from a 3D image data set. In order to achieve enhanced image display, the invention proposes a method which includes the following steps:

a) forming and displaying a visualization of the volume,

b) defining a point of rotation in the visualized volume,

c) selecting a variable cut plane which extends through the visualized volume and through the point of rotation, and

d) simultaneously displaying two complementary sectional images of each of the two sub-volumes of the volume which are separated by the cut plane.

The invention relates to a method of and a device for the simultaneous display of at least two sectional images taken through a volume reconstructed from a 3D image data set.

WO 98/32371 A1 discloses a CT method in which a plurality of images is formed from a 3D data set of a volume so as to be displayed simultaneously for diagnostic purposes. For example, it is proposed to define a cut plane through the volume and to display a pair of axial images, one image representing a first sub-volume from a first direction whereas the other image represents a second, complementary sub-volume from the opposite direction. This method of display is comparable to the cutting in half of an apple and observing the respective cut faces of the two halves of the apple.

It is an object of the invention to improve the known method of display. This object is achieved in accordance with the invention by way of a method as disclosed in claim 1, which method includes the following steps:

a) forming and displaying a visualization of the volume,

b) defining an arbitrarily selectable point of rotation in the visualized volume,

c) selecting a variable cut plane which extends through the visualized volume and through the point of rotation,

d) simultaneously displaying two complementary sectional images of each of the two sub-volumes of the volume which are separated by the cut plane.

The invention is based on the recognition of the fact that in the known display method, upon rotation of the cut plane around a single possible point of rotation, object details which may be of interest and are not necessarily situated in the cut plane are no longer present in rotated images, meaning that quasi they wander out of the image. In order to enable such object details to be displayed, therefore, it would be necessary to define a new cut plane which again extends through the object detail of interest, i.e. renewed “focusing” on these object details should take place.

In order to avoid this problem, therefore, in accordance with the invention it is proposed to define a freely selectable point of rotation in the visualized volume wherethrough the cut plane extends and about which the cut plane can also be rotated. Preferably, this point of rotation is defined at locations with important object details, for example, in complex vascular deformations such as, for example, aneurysms, AVMs or stenoses, but also in the vicinity of bone fractures. Furthermore, it is arranged that each time two complementary sectional images are displayed along the cut plane extending through the point of rotation, that is, for example in the case of a horizontal cut plane, a sectional image of the sub-volume of the volume which is situated above the cut plane and a complementary sectional image of the sub-volume of the volume which is situated underneath the cut plane. Thus, it can no longer occur that upon rotation of the cut planes the object details of interest which are situated around the point of rotation wander out of the sectional images displayed, because such object details of interest are always situated in the cut plane, irrespective of the position of the cut plane.

In order to enhance the diagnostic value of the images displayed, preferably a plurality of cut planes extending through the point of rotation is selected and each time two complementary sectional images are displayed for each cut plane. The physician making the diagnosis can thus define a plurality of cut planes through the point of rotation in order to obtain images from different directions of the object details situated around the point of rotation.

Preferably, the cut plane is also rotatable in the point of rotation and the display of the complementary sectional images is adapted directly to the changed position of the sectional images in the case of a rotation of the sectional images. The physician making the diagnosis can then rotate or tilt the cut plane around the point of rotation, for example, by means of a computer mouse, while nevertheless obtaining at the same time the two complementary sectional images adapted to the new position of the cut plane.

In addition to the position of the cut plane, the viewing angle of each single sectional image is also individually selectable. This is important notably when the sectional images formed render a three-dimensional impression of the sub-volume displayed, that is, for example, when so-called “volume-rendered” images are concerned. Alternatively, however, the sectional images may also be 2D projection images or maximum intensity projection images.

Claim 6 discloses a device in accordance with the invention for carrying out he described method. The invention also relates to a computer program as disclosed in claim 7 which includes program means for making a computer carry out the steps of the method as disclosed in claim 1.

The invention will be described in detail hereinafter with reference to the drawings. Therein:

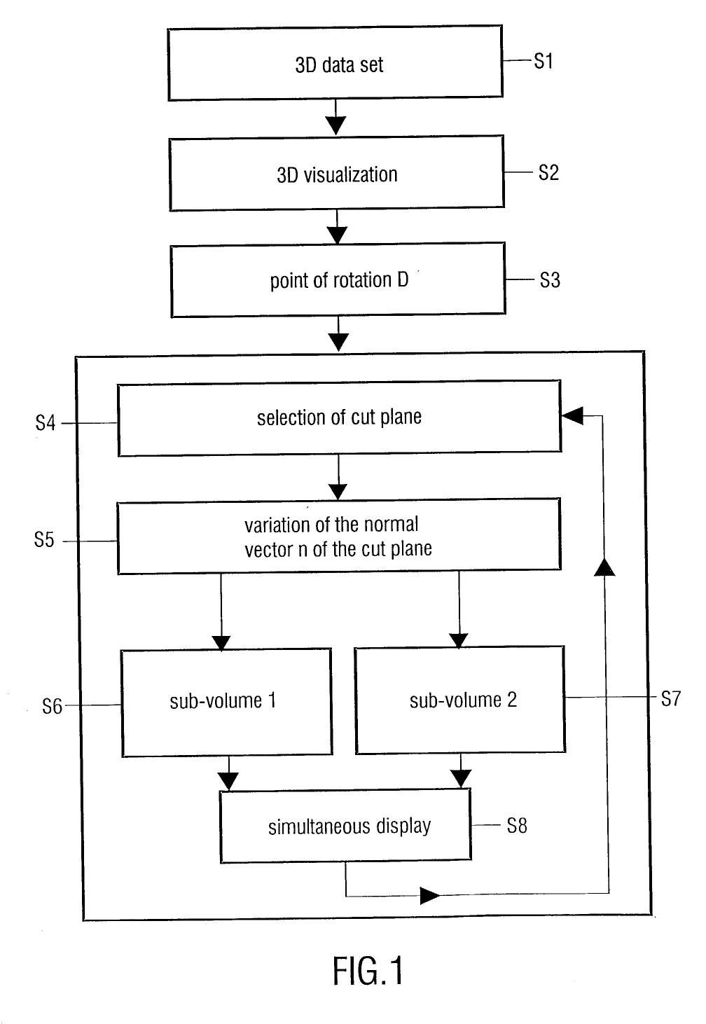

FIG. 1 shows a flow chart illustrating the method in accordance with the invention, and

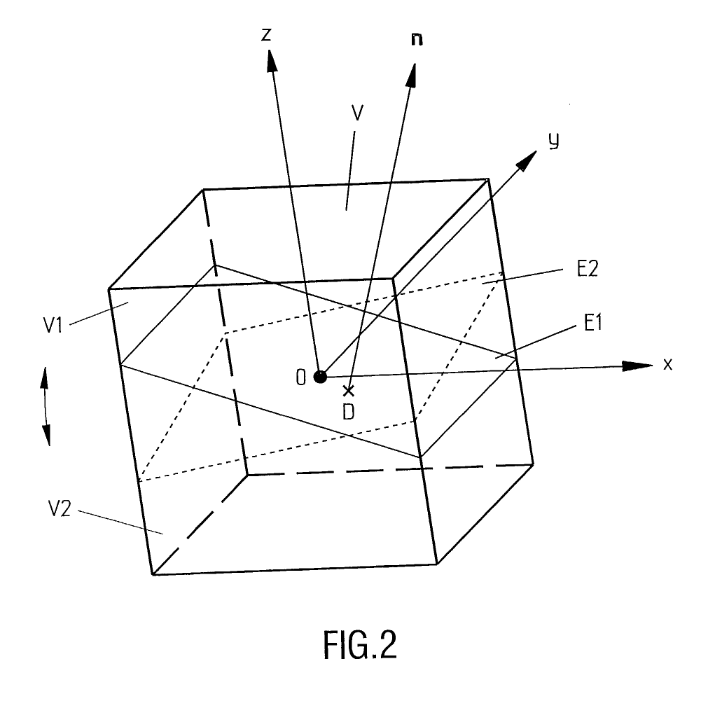

FIG. 2 shows a volume with two cut planes.

FIG. 1 shows a flow chart illustrating the method in accordance with the invention. In a first step S1 a 3D image data set of a volume is reconstructed. In a second step S2 the volume is visualized; for example, a three-dimensional image of the volume is formed and displayed on a monitor. The physician making the diagnosis can then define a point of rotation in this image in the step S3. Such a point of rotation is preferably defined, using a three-dimensional cursor, in a location in which important object details are situated, that is, details which have to be observed from different directions for diagnostic purposes.

In the step S4 one or more cut planes can be chosen in the visualized volume so as to extend through the previously defined point of rotation. The position of this cut plane can be simply changed during the subsequent step S5; it can notably be rotated or tilted around the point of rotation. This is carried out preferably by varying the normal vector n of the cut plane, for example, by control on the display screen by means of the computer mouse. On the basis of the cut plane the volume is subsequently subdivided into two sub-volumes 1 and 2 in the steps S6 and S7, said sub-volumes being complementary to one another; this means that the sub-volume 1 is situated, for example, above the instantaneous cut plane while the sub-volume 2 is situated underneath this cut plane. Finally, in step S8 the two sub-volumes 1 and 2 can be simultaneously displayed, for example, by displaying “volume-rendered” images which provide a three-dimensional impression of the relevant sub-volume.

As appears from FIG. 1, the steps S4 to S8 form a loop so that they can be executed time and again after the point of rotation has been defined in the step S3. Notably the position of the cut plane can be changed time and again, all cut planes always extending through the point of rotation, so that the object details of interest which are situated at the point of rotation will always be visible in the images ultimately displayed in the step S8. Additionally, however, other parameters can also be varied. For example, the type of display of the images can be changed so that instead of volume-rendered images projection images or other images of the sub-volumes are formed and displayed.

FIG. 2 shows a volume V for the purpose of illustration. This volume is subdivided into two sub-volumes V1 and V2 by means of the cut plane E1 which extends through the point of rotation D. The position of the cut plane can be changed by varying the normal vector n of the cut plane E1. Such a changed position is shown as the cut plane E2 which also extends through the point of rotation D but subdivides the volume V in other sub-volumes. In accordance with the invention a respective sectional image of the first and the second sub-volume V1 and V2 is formed in each position of the cut plane, said sectional image being formed from the cut plane, that is, similar to the previously mentioned observation of the cut faces of two halves of an apple.

In accordance with the invention, the viewing angle of the cut faces can also be changed in the case of a fixed position of the cut plane; this may be advantageous notably in the case of images rendering a three-dimensional impression.

1. A method for the simultaneous display of at least two sectional images taken through a volume reconstructed from a 3D image data set, which method includes the steps of:
a) forming and displaying a visualization of the volume,
b) defining a point of rotation in the visualized volume,
c) selecting a variable cut plane which extends through the visualized volume and through the point of rotation,
d) simultaneously displaying two complementary sectional images of each of the two sub-volumes of the volume which are separated by the cut plane.

2. A method as claimed in claim 1, characterized in that a plurality of cut planes extending through the point of rotation is selected and each time two complementary sectional images are displayed for each cut plane.

3. A method as claimed in claim 1, characterized in that the cut plane is rotatable about the point of rotation and that upon rotation of the sectional images the display of the complementary sectional images is adapted directly to the changed position of the sectional images.

4. A method as claimed in claim 1, characterized in that the viewing angle can be individually chosen for each sectional image displayed.

5. A method as claimed in claim 1, characterized in that the sectional images are volume-rendered images or projection images.

6. A device for the simultaneous display of at least two sectional images taken through a volume reconstructed from a 3D image data set, which device includes:
a) an image computer for forming and displaying a visualization of the volume,
b) means for defining a point of rotation in the visualized volume,
c) selection means for selecting a variable cut plane which extends through the visualized volume and through the point of rotation, and
d) means for the simultaneous display of two complementary sectional images of each of the two sub-volumes of the volume which are separated by the cut plane.

7. A computer program with program means for making a computer carry out the steps of the method as claimed in claim 1.
